(19) United States
(12) Patent Application Publication
(10) Pub. No.: US 2010/0002453 A1
(43) Pub. Date: Jan. 7, 2010

(54) ILLUMINATING DEVICE AND ANNULAR HEAT-DISSIPATING STRUCTURE THEREOF

(76) Inventors: Hsiang-Chen WU, Taoyuan Hsien (TW); Chin-Ming Cheng, Taoyuan Hsien (TW); Chih-Hao Yu, Taoyuan Hsien (TW); Te-Hsin Chiu, Taoyuan Hsien (TW); Han-Chung Hsu, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/259,601

(22) Filed: Oct. 28, 2008

(30) Foreign Application Priority Data
Jul. 4, 2008 (TW) 097125157

(51) Int. Cl. F21V 29/02

(52) U.S. Cl. 362/373

(57) ABSTRACT

An illuminating device and an annular heat-dissipating structure thereof. The annular heat-dissipating structure includes a plurality of heat-dissipating units disposed circumambiently. Each heat-dissipating unit includes a flake and at least one first assembling portion connected with the flake, so that the adjacent heat-dissipating units can be connected with each other.

### CROSS REFERENCE TO RELATED APPLICATIONS

This Non-provisional application claims priority under 35 U.S.C. §119(a) on Patent Application No(s). 097125157 filed in Taiwan, Republic of China on Jul. 4, 2008, the entire contents of which are hereby incorporated by reference.

### BACKGROUND OF THE INVENTION

1. Field of Invention

The present invention relates to an illuminating device and an annular heat-dissipating structure thereof. More particularly, the present invention relates to a heat-dissipating structure composed of a plurality of heat-dissipating units, which are disposed circumambiently.

2. Related Art

In the present marketing, the light-emitting diodes (LED) have been used as the light source of various illuminating devices, such as the street lamp, wall lamp, desk lamp, light bulb and light tube. Taking the light bulb or tube for example, the LED illuminating device, which is used in office or house, is usually manufactured to fit the common socket, such as the E26, E27, MR16 or GU4 socket. Therefore, the LED illuminating device can directly replace the conventional light bulb or tube.

However, in a light bulb with the light source made of LED, the heat-dissipation design is very important. In particularly, when the power of the light bulb increases, the importance of the heat-dissipating design increases accordingly. The conventional heat-dissipating method for the LED light bulb is to utilize the heat sink with the fins made by aluminum extrusion or casting. As shown in FIG. 1, a conventional illuminating device includes a plurality of LEDs 11, an aluminum substrate 12, a thermal conducting plate 13 and a heat sink 14. The LEDs 11 are disposed on the aluminum substrate 12. The aluminum substrate 12 and the heat sink 14 are connected through the thermal conducting plate 13. This structure is applied to most of the present illuminating devices, but the heat sink 14 may be not enough for dissipating the heat generated by the illuminating device with high watts. In addition, since the heat sink is made by aluminum extrusion or casting, the thickness of the thermal conducting plate 13 can not be reduced due to the limitation of manufacturing process. Thus, in the limited space, the number of the thermal conducting plates 13 is also limited, so that the total heat-dissipating surface can not be increased. Moreover, the conventional structure utilizes the thermal conducting plate to connect the aluminum substrate and the heat sink, so that the additional material cost is necessary.

### SUMMARY OF THE INVENTION

In view of the foregoing, the present invention is to provide an illuminating device and an annular heat-dissipating structure thereof that can decrease the material cost and increase the number of the thermal conducting plates and the heat-dissipating surface.

To achieve the above, the present invention discloses an annular heat-dissipating structure, which includes a plurality of heat-dissipating units disposed circumambiently. Each heat-dissipating unit includes a flake and at least one first assembling portion. The first assembling portion is connected with the flake so as to connect one heat-dissipating unit with the adjacent heat-dissipating unit.

The heat-dissipating unit further includes a bending portion formed by bending one end of the flake. The bending portion is a planar surface or an oblique surface, and the first assembling portion is protruded from the flake or the bending portion. The heat-dissipating unit further includes a second assembling portion correspondingly connected to the first assembling portion of the adjacent heat-dissipating unit. A heat source can be directly attached to the bending portion, a discontinuous plane composed of the lateral surfaces of a plurality of heat-dissipating units, or an annular surface or a cone-shaped surface formed by coupling the bending portions of the adjacent heat-dissipating units.

The width of one end of the bending portion is smaller than that of the other end of the bending portion. The heat-dissipating structure can be circular ring-shaped, elliptic ring-shaped, triangular ring-shaped, rectangular ring-shaped, polygonal ring-shaped, annular cone-shaped, annular pyramid or asymmetric annular pyramid.

The annular heat-dissipating structure further includes a substrate disposed between the heat source and the annular heat-dissipating structure, so that the heat source can be attached to the annular heat-dissipating structure through the substrate. Alternatively, the substrate and the heat source can be disposed at two ends of the annular heat-dissipating structure.

The annular heat-dissipating structure is suitable for a light-emitting diode (LED), a laser diode (LD), an organic electro-luminescence device (OELD) or a semiconductor light source. The heat-dissipating units are preferably connected by laser welding, gluing, adhering or locking, and the heat-dissipating units are preferably made of copper, aluminum, iron or magnesium alloy. The heat-dissipating structure further includes an airflow passage disposed at the center thereof, and the heat-dissipating units are disposed around the airflow passage.

In addition, to achieve the above, the present invention also discloses an illuminating device, which includes an annular heat-dissipating structure and a heat source. The annular heat-dissipating structure includes a plurality of heat-dissipating units disposed circumambiently. Each of the heat-dissipating units includes a flake and at least one assembling portion connected with the flake for connecting one heat-dissipating unit with the adjacent heat-dissipating unit. The heat source is disposed on the heat-dissipating structure.

The heat source is a light-emitting diode (LED), a laser diode (LD), an organic electro-luminescence device (OELD) or a semiconductor light source. The illuminating device further includes a lampshade disposed outside the heat-dissipating structure and the heat source. The lampshade has one or more openings, and the configuration of the openings can be determined according to the actual need.

The illuminating device further includes a base, and the heat-dissipating structure is fixed on the base. The base has one or more openings, and the configuration of the openings can be determined according to the actual need.

The illuminating device further includes a power connector, such as the E10/E11, E26/E27, E39/E40, MR16 or GU4 connector.

The illuminating device further includes an airflow passage disposed at the center of the annular heat-dissipating structure. The heat-dissipating units are disposed around the airflow passage. The illuminating device further includes a fan, and the fan and the heat source are disposed at two ends of the airflow passage or in the airflow passage.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is an exploded diagram of the conventional illuminating device;

FIGS. 2A to 2E are schematic diagrams showing an annular heat-dissipating structure according to a first embodiment of the present invention;

FIGS. 3A to 3D are schematic diagrams showing an annular heat-dissipating structure according to a second embodiment of the present invention;

FIGS. 4A to 4D are schematic diagrams showing an annular heat-dissipating structure according to a third embodiment of the present invention; and

FIG. 5 is an exploded diagram of an illuminating device according to the embodiment of the present invention.

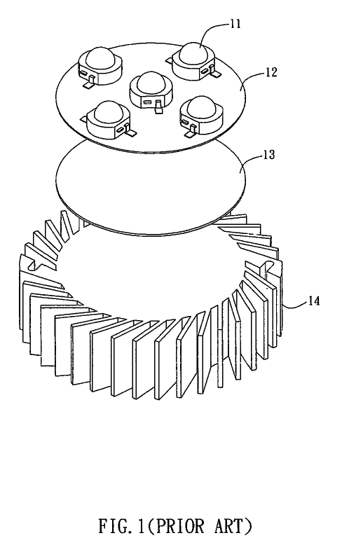

### DETAILED DESCRIPTION OF THE INVENTION

The present invention will be apparent from the following detailed description, which proceeds with reference to the accompanying drawings, wherein the same references relate to the same elements.

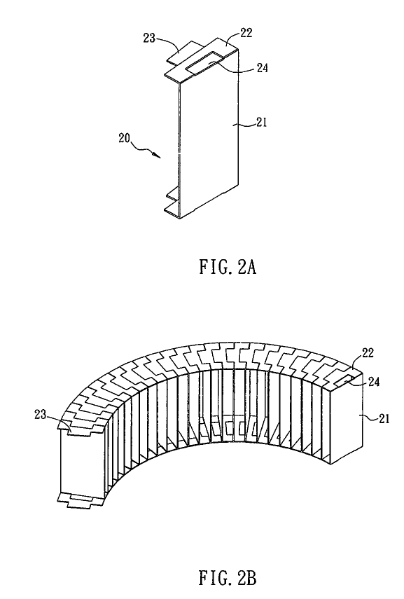

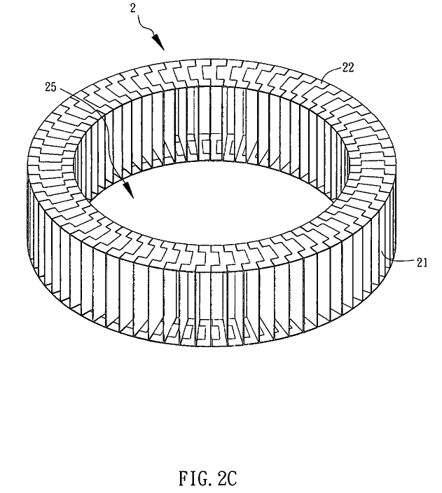

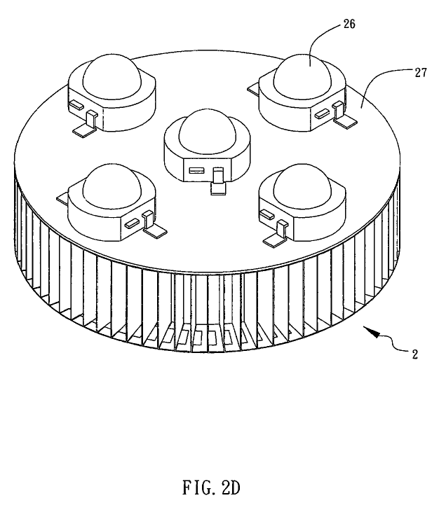

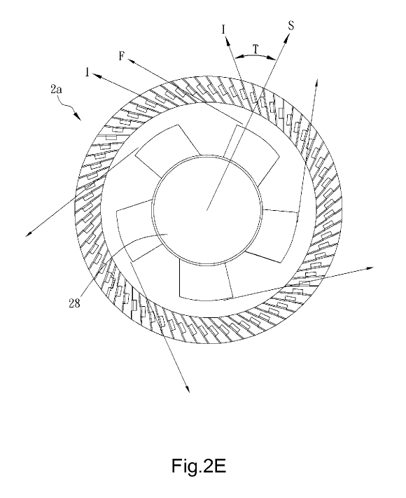

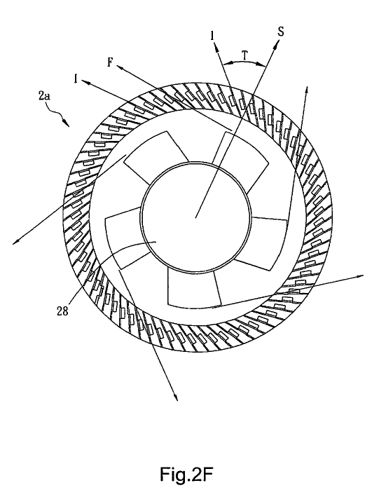

FIGS. 2A to 2D are schematic diagrams showing an annular heat-dissipating structure 2 according to a first embodiment of the present invention. With reference to FIGS. 2A to 2D, the annular heat-dissipating structure 2 has an airflow passage 25 disposed at the center thereof. As shown in FIG. 2C, the annular heat-dissipating structure 2 includes a plurality of heat-dissipating units 20 disposed around the airflow passage 25. Each heat-dissipating unit 20 includes a flake 21, a bending portion 22, a first assembling portion 23 and a second assembling portion 24. As shown in FIG. 2A, the bending portion 22 can be formed by bending two ends of the flake 21, and the width of one end of the bending portion 22 is smaller than that of the other end of the bending portion 22. Thus, the heat-dissipating units 20 can be disposed circumambiently to form the annular heat-dissipating structure 2. The first assembling portion 23 is protruded from the bending portion 22, and the second assembling portion 24 is disposed corresponding to the first assembling portion 23. Thus, as shown in FIG. 2B, the second assembling portion 24 of any heat-dissipating unit 20 can connect to the first assembling portion 23 of the adjacent heat-dissipating unit 20. The first assembling portion 23 can be a protrusion, and the second assembling portion 24 can be a hole. The bending portions 22 of the adjacent heat-dissipating units 20 are coupled to form an annular surface, so that a heat source 26 can be attached to the annular surface. As shown in FIGS. 2C and 2D, the heat source 26 can connect to the annular heat-dissipating structure 2 through a substrate 27. In the embodiment, the substrate 27 and the annular heat-dissipating structure 2 can be connected by welding.

The heat source is preferably a light-emitting diode (LED), a laser diode (LD), an organic electro-luminescence device (OELD) or a semiconductor light source. The first assembling portion and the second assembling portion of adjacent heat-dissipating units are preferably connected by laser welding, gluing, adhering or locking. The heat-dissipating units are preferably made of copper, aluminum, iron, magnesium alloy or a high thermoconductive material. The annular heat-dissipating structure can be circular ring-shaped, elliptic ring-shaped, triangular ring-shaped, rectangular ring-shaped, polygonal ring-shaped, annular cone-shaped, annular pyramid or asymmetric annular pyramid.

As shown in FIG. 2E, the difference between the annular heat-dissipating structures 2 and 2a is in that an extending direction I of a conjunction line between the bending portion and the flake tilts with an angle T related to a radial direction S of the heat-dissipating structure 2a. The angle T can be, for example, an acute angle. In this case, the design of the angle T can allow the extending direction I to be substantially parallel to the airflow direction of the fan 28, which is, for example, the tangent direction F of the blade. Thus, the airflow generated by the fan 28 can smoothly pass through the spaces between the flakes, thereby decreasing the resistance and noise as the air passes through the flakes. Furthermore, because the spaces between the flakes for allowing the airflow to pass through are increased, the heat-dissipating efficiency can be further improved.

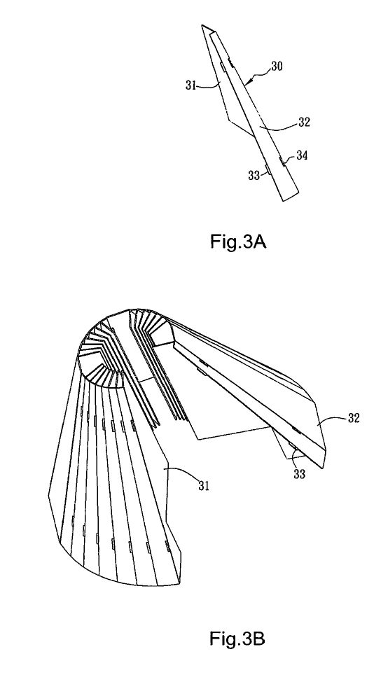

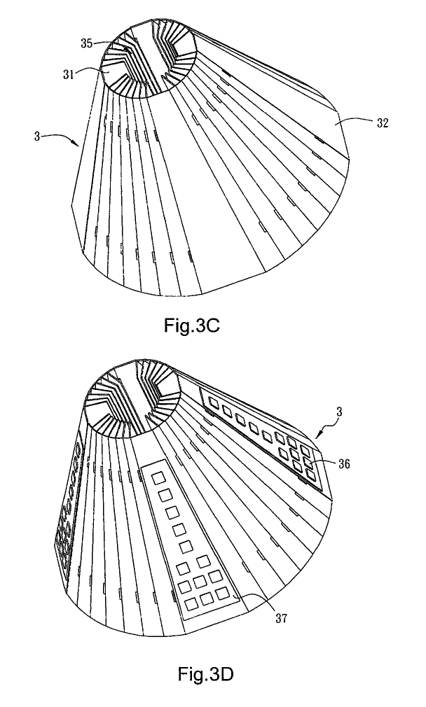

FIGS. 3A to 3D are schematic diagrams showing an annular heat-dissipating structure 3 according to a second embodiment of the present invention. Referring to FIGS. 3A to 3D, the annular heat-dissipating structure 3 also includes a plurality of heat-dissipating units 30 disposed circumambiently. Each heat-dissipating unit 30 includes a flake 31, a bending portion 32, a first assembling portion 33 and a second assembling portion 34. As shown in FIG. 3A, the difference between the first and second embodiments is in that the bending portion 32 is an oblique surface. When the heat-dissipating units 30 are disposed around the center airflow passage 35, the oblique surface of the bending portions 32 of the heat-dissipating units 30 can be coupled to form a cone-shaped surface. As shown in FIGS. 3B and 3C, the heat-dissipating units 30 can be an annular cone-shaped structure. As shown in FIG. 3D, the substrate 37 carrying the heat source 36 can be attached to bending portion 32 of the heat-dissipating unit 30. In addition, the heat source 36 can be directly attached to the cone-shaped surface formed by the bending portions 32. Alternatively, the annular heat-dissipating structure 3 can be annular pyramid or asymmetric annular pyramid.

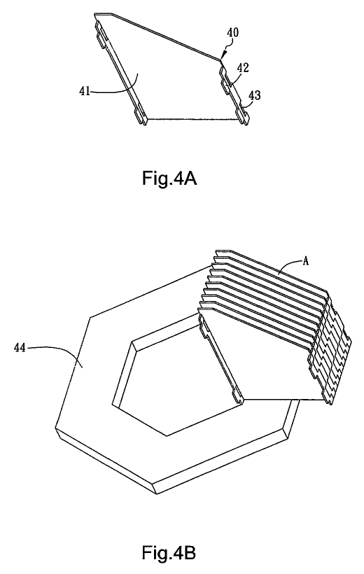

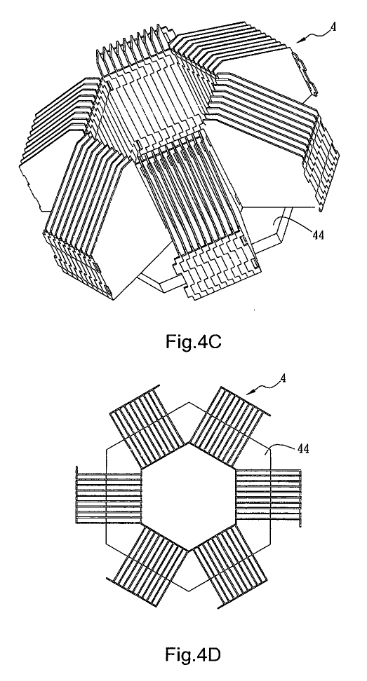

FIGS. 4A to 4D are schematic diagrams showing an annular heat-dissipating structure 4 according to a third embodiment of the present invention. Referring to FIGS. 4A to 4D, the annular heat-dissipating structure 4 includes a plurality of heat-dissipating units 40 disposed circumambiently. Each heat-dissipating unit 40 includes a flake 41, a first assembling portion 42 and a second assembling portion 43. As shown in FIG. 4A, the difference between the third embodiment and the above-mentioned embodiments is in that the heat-dissipating units 40 are disposed on a hexagonal or polygonal substrate 44. When a certain amount of the heat-dissipating units 40 are assembled, the heat-dissipating units 40 can be disposed along the edges of the hexagonal or polygonal substrate 44. As shown in FIG. 4B, several sets of the assembled heat-dissipating units 40 are arranged together on the hexagonal or polygonal substrate 44, so that the heat-dissipating structure of an annular hexagonal pyramid can be formed. As shown in FIGS. 4C and 4D, the heat-dissipating units 30 are connected to each other so as to form a discontinuous surface A, so that the heat source can be attached to the discontinuous surface A.

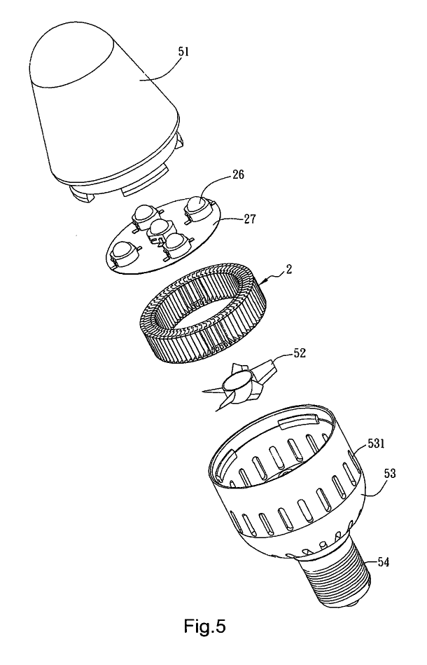

FIG. 5 is an exploded diagram of an illuminating device according to the embodiment of the present invention. The illuminating device includes a lampshade 51, a heat source 26, a substrate 27, an annular heat-dissipating structure 2, a fan 52, a base 53 and a power connector 54. The power connector 54 can be, for example but not limited to, the common E10/E11, E26/E27, E39/E40, MR16 or GU4 power connector. The heat source 26 and the substrate 27 are connected and then attached to the annular heat-dissipating structure 2. The heat-dissipating structure 2 and the fan 52 are fixed on the base 53. The base 53 includes a plurality of openings 53 1. To be noted, the configuration of the openings 531 can be determined according to the actual need. In addition, the surface of the lampshade 51 may include several openings for increasing the airflow flux. An airflow passage is disposed at the center of the annular heat-dissipating structure 2. The fan 52 can be disposed in the airflow passage or between the annular heat-dissipating structure 2 and the base 53. The lampshade 51 is transparent or semiopaque.

In summary, the illuminating device and annular heat-dissipating structure of the present invention include the metal fins, which are connected by assembling. Thus, the thickness of the fin is not limited, so that the number of the fins within the same volume of the heat-dissipating structure can be greater than that made by the aluminum extrusion or casting. Accordingly, the invention can relatively increase the heat-dissipating area. The material of the heat-dissipating structure is not limited and can be copper or other high thermoconductive materials. For example, the heat conducting coefficient of the copper is three times greater than that of aluminum, so that the heat-dissipating effect can be greatly enhanced. In addition, the heat-dissipating structure, heat source and substrate of the invention can be connected by welding, so the conventional thermal conducting plate is unnecessary, thereby reducing the material cost and simplifying the manufacturing steps.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A heat-dissipating structure comprising: a plurality of heat-dissipating units, each of which comprises:
a flake; and
at least one first assembling portion connected with the flake for connecting one heat-dissipating unit with the adjacent heat-dissipating unit.

2. The heat-dissipating structure according to claim 1, wherein the heat-dissipating unit further comprises a second assembling portion correspondingly connected to the first assembling portion of the adjacent heat-dissipating unit.

3. The heat-dissipating structure according to claim 2, wherein the first assembling portion is a protrusion, and the second assembling portion is a hole.

4. The heat-dissipating structure according to claim 1, wherein lateral surfaces of the heat-dissipating units form a discontinuous plane, and a heat source is attached on the discontinuous plane.

5. The heat-dissipating structure according to claim 1, wherein the heat-dissipating unit further comprises a bending portion formed by bending one end of the flake, and a heat source is attached on the bending portion.

6. The heat-dissipating structure according to claim 5, wherein an extending direction of a conjunction line between the bending portion and the flake tilts with an angle related to a radial direction of the heat-dissipating structure

7. The heat-dissipating structure according to claim 5, wherein the bending portion is a planar surface or an oblique surface, the bending portion of one heat-dissipating unit is coupled to that of the adjacent heat-dissipating unit to form an annular surface, and the first assembling portion is protruded from the bending portion.

8. The heat-dissipating structure according to claim 5, wherein the width of one end of the bending portion is smaller than that of the other end of the bending portion.

9. The heat-dissipating structure according to any of claims 1, wherein the heat-dissipating structure is circular ring-shaped, elliptic ring-shaped, triangular ring-shaped, rectangular ring-shaped, polygonal ring-shaped, annular cone-shaped, annular pyramid or asymmetric annular pyramid.

10. The heat-dissipating structure according to any of claims 1, further comprising a substrate connected to the heat-dissipating structure.

11. The heat-dissipating structure according to claim 10, wherein the substrate is a polygonal substrate, and the substrate is connected to the heat-dissipating structure by welding.

12. The heat-dissipating structure according to any of claims 1, wherein the heat-dissipating units are connected by laser welding, gluing, adhering or locking, and the heat-dissipating units are made of copper, aluminum, iron, magnesium alloy or a high thermoconductive material.

13. The beat-dissipating structure according to any of claims 1, further comprising an airflow passage disposed at the center of the heat-dissipating structure, wherein the heat-dissipating units are disposed around the airflow passage.

14. An illuminating device, comprising:
a heat-dissipating structure comprising a plurality of heat-dissipating units, wherein each of the heat-dissipating units comprises a flake and at least one assembling portion connected with the flake for connecting one heat-dissipating unit with the adjacent heat-dissipating unit; and
a heat source disposed on the heat-dissipating structure.

15. The illuminating device according to claim 14, wherein the heat source is a light-emitting diode (LED), a laser diode (LD), an organic electro-luminescence device (OELD) or a semiconductor light source.

16. The illuminating device according to claim 14, further comprising a lampshade disposed outside the heat-dissipating structure and the heat source.

17. The illuminating device according to claim 16, wherein the lampshade has one or more openings, and the lampshade is transparent or semiopaque.

18. The illuminating device according to claim 14, further comprising a base, wherein the heat-dissipating structure is fixed on the base.

19. The illuminating device according to claim 18, wherein the base has one or more openings.

20. The illuminating device according to claim 14, further comprising a power connector.

21. The illuminating device according to claim 14, further comprising a fan, wherein the fan and the heat source are disposed at two ends of the heat-dissipating structure, respectively, or disposed inside an airflow passage of the heat-dissipating structure.

22. The illuminating device according to claim 14, further comprising a substrate, wherein the substrate is disposed between the heat source and the heat-dissipating structure, or the substrate and the heat source are disposed at two ends of the heat-dissipating structure, respectively.
